(19) United States
(12) Patent Application Publication
(10) Pub. No.: US 2007/0025046 A1
(43) Pub. Date: Feb. 1, 2007

(54) Electromagnetic dual-coil valve actuator with permanent magnet

(76) Inventors: Christophe Maerky, Saint-Ouen L'Aumone (FR); Geraint Jewell, Owlthorpe Sheffield (GB); Richard Clark, Sheffield (GB); Paul Stewart, Sheffield (GB)

Correspondence Address: BIRCH STEWART KOLASCH & BIRCH, PO BOX 747, FALLS CHURCH, VA, 22040-0747, US

(21) Appl. No.: 10/540,015

(22) PCT Filed: Dec. 19, 2003
(86) PCT No.: PCT/FR03/03807

§ 371 Date: Oct. 3, 2006

(30) Foreign Application Priority Data
Dec. 23, 2002 (FR) 0216520

(51) Int. Cl. H01H 47/00

(52) U.S. Cl. 361/160

(57) ABSTRACT

The invention relates to a dual-coil electromagnetic valve actuator having a permanent magnet and an actuator member (11) movable between two extreme positions under the effect of a resilient member and two electromagnets each comprising a core having a T-shaped first core portion (18) with a base (19) connected to a central branch (20) with a coil (21) disposed thereabout, the first core portion (18) being placed in a U-shaped second core portion (22) having a base (23) connected to outer branches (24) which extend parallel to the central branch (20) of the first core portion (18), a permanent magnet (25) being interposed between the base of the first core portion (18) and the base of the second core portion (22). In at least one of the electromagnets, the base (19) of the T-shaped first core portion (18) extends so as to co-operate with the outer branches (24) of the U-shaped second core portion (22) to present airgaps (e) of size much smaller than a distance between the base (19) of the T-shaped first core portion and the base (23) of the U-shaped second core portion.

The invention relates to a dual-coil electromagnetic valve actuator with a permanent magnet.

### BACKGROUND OF THE INVENTION

A dual-coil electromagnetic valve actuator with a permanent magnet is known, e.g. from document JP-A-2002-130510 TOYOTA, having an actuator member that is movable between two extreme positions under the effect of a resilient member and two electromagnets, each comprising a core having a T-shaped first core portion with a base connected to a central branch about which a coil is disposed, the first coil portion being placed in a U-shaped second coil portion having a base and outer branches that extend parallel to the central branch of the T-shaped first core portion, a permanent magnet being interposed between the base of the first core portion and the base of the second core portion.

Valve actuators need to operate at temperatures lying in the range approximately 100 degrees Celsius (° C.) to 200° C. For temperatures of this order, the magnetization/demagnetization cycle of permanent magnets presents a large amount of hysteresis, such that at these temperatures the flux needed to demagnetize a permanent magnet is less than the flux needed to magnetize the permanent magnet.

Under such conditions, there therefore exists a risk that the intensity of the alternating flux generated by the electromagnet and passing through the permanent magnet will exceed the demagnetization threshold thereof, while still remaining below the magnetization threshold, which leads to the permanent magnet being progressively demagnetized while the actuator is in operation. This demagnetization leads to a reduction in the ability of magnets to hold the armature in its extreme positions, and to an increase in the electricity consumption of the electromagnets since they need to compensate for the loss of force exerted by the permanent magnets.

To avoid that risk, proposals are made in document JP-A-08 004 546 ISUZU to provide a bypass between the two core portions, to define a magnetic path for the coil flux so that it passes outside the permanent magnet. The bypass is constituted by a projection on one of the core portions extending parallel to the direction of magnetization of the magnet so as to co-operate with the other core portion to present an airgap that is much smaller than the thickness of the permanent magnet. The major fraction of the flux from the coil is channeled via the bypass, and only residual flux passes through the permanent magnet, thereby protecting it from the risk of being demagnetized.

When that teaching is applied to the prior art actuator, projections need to be provided at the end of the base of the T-shaped core portion, which projections extend parallel to the direction of magnetization of the permanent magnet, and thus perpendicularly to the base, towards the base of the U-shaped second core portion so as to co-operate therewith by presenting a small airgap. Such a modification has the drawback of giving the base of the T-shaped core portion a shape that is complex. It is also necessary to space apart the outer branches of the U-shaped second core portion in order to give these projections sufficient section, and that increases the size of the actuator.

### OBJECT OF THE INVENTION

An object of the invention is to provide a permanent magnet actuator including a permanent magnet bypass for the coil flux while avoiding the above-mentioned drawbacks of the ISUZU document.

### BRIEF SUMMARY OF THE INVENTION

According to the invention, an actuator is proposed of the above-specified type, for which, in at least one of the electromagnets, the base of the T-shaped first core portion extends so as to co-operate with the outer branches of the U-shaped second core portion to present airgaps of size much smaller than a distance between the base of the T-shaped first core portion and the base of the U-shaped second core portion.

The bypass airgaps as provided in this way no longer extend parallel to the direction of magnetization of the permanent magnet, but perpendicularly relative thereto. This disposition enables the bypasses to be made merely by lengthening the base of the T-shaped first core portion, which is particularly simple to fabricate and does not increase the size of the actuator.

### BRIEF DESCRIPTION OF THE DRAWINGS

The invention will be better understood in the light of the following description given with reference to the figures of the accompanying drawings, in which:

FIG. 1 is a section view of an actuator of the invention installed on an engine cylinder head, with the actuator in a neutral position;

FIG. 2 is a fragmentary symbolic view in section showing the actuator of the invention with flux traveling through the actuator while attracting the armature towards the core;

FIG. 3 is a view analogous to FIG. 2 showing the flux traveling through the actuator while holding the armature against the core; and

FIG. 4 is a view analogous to FIG. 2 showing the flux traveling through the actuator while separating the armature from the core.

### DETAILED DESCRIPTION OF THE INVENTION

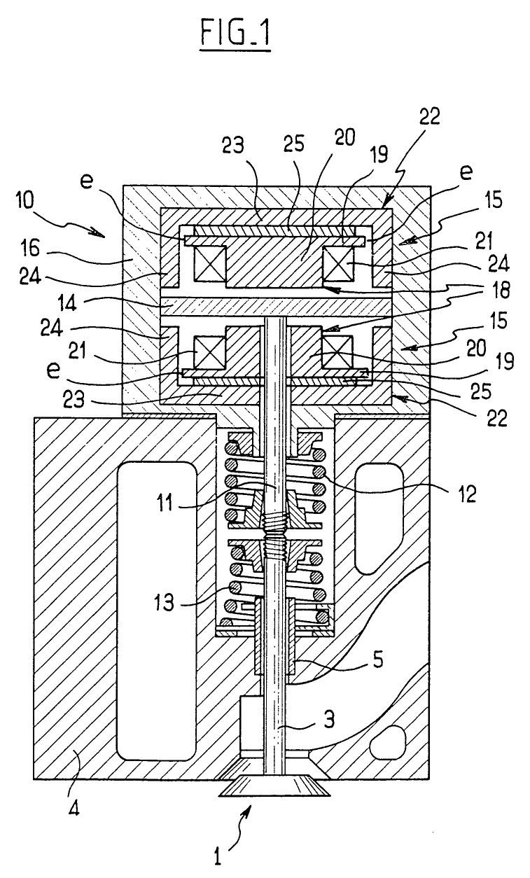

With reference to FIG. 1, and in known manner, a dual-coil electromagnet actuator 10 comprises a non-magnetic housing 16 mounted on an engine cylinder head 4 to actuate a valve 1. The stem 3 of the valve 1 is mounted to slide in a bearing 5 of the cylinder head 4.

The actuator 10 comprises a pusher 11 which slides on the same axis as the stem of the valve. The end of the stem 3 of the valve 1 and the end of the pusher 11 are urged towards each other by two opposing springs 12 and 13 acting respectively on the pusher 11 and on the stem 3 of the valve. The springs 12 and 13 define an equilibrium point for the pusher 11, in which position the valve is half open.

The pusher 11 is secured to an armature 14 mounted to travel between two electromagnets 15 (described in greater detail below). The stroke of the pusher 11 is thus defined between a top extreme position where the armature 14 comes into abutment against the core of the top electromagnet 15, and a bottom extreme position where the armature 14 comes into abutment against the core of the bottom electromagnet 15, the extreme positions corresponding respectively to the open and closed positions of the valve 1.

In operation, the pusher 11 is moved from one extreme position to the other by the combined action of the springs 12 and 13 and of the electromagnets 15 attracting the armature 14 in alternation.

In the embodiment of the invention shown in FIG. 1, each of the electromagnets 15 comprises a core having a first core portion 18 that is generally T-shaped, comprising a base 19 and a central branch 20 around which the coil 21 is disposed.

The core also comprises a second core portion 22 that is generally U-shaped, comprising a base 23 and two outer branches 24 which extend parallel on either side of the central branch 20 of the first core portion 18.

The first core portion 18 is disposed inside the second core portion 22, with a permanent magnet 25 being interposed between the base 19 of the first core portion 18 and the base 23 of the second core portion 22.

The base 19 of the first core portion 18 co-operates with the outer branches 24 of the second core portion 22 to define airgaps e of size much smaller than the distance between the base 19 of the first core portion and the base 23 of the second core portion.

The ends of the outer branches 24 of the second core portion 22 and the central branch 20 of the first core portion 18 form portions of an active face 26 of the core of the electromagnet constituting an abutment for the armature 14.

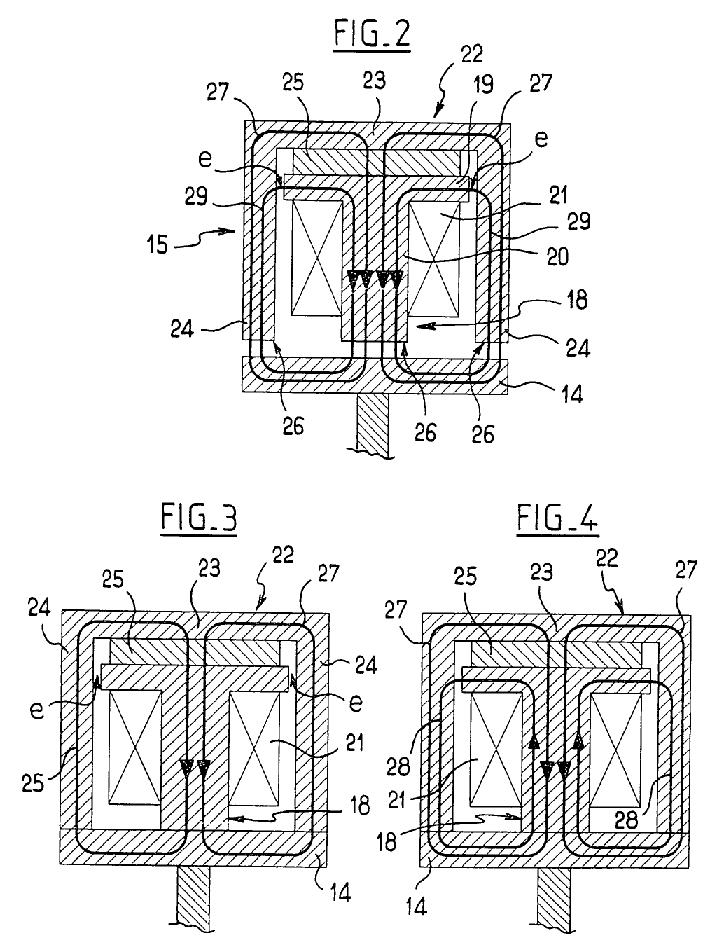

The operation of the actuator of the invention is described below with reference to FIGS. 2 to 4 which show the top electromagnet 15 only.

In order to attract the armature 14 towards the active face 16 of the core of the electromagnet 15, the coil 21 is powered so as to generate flux 29 in the same direction as the flux 27 of the permanent magnet 25, as shown in FIG. 2. The flux 29 generated by the coil 21 passes via the central branch 20 of the first core portion, transits towards the outer branches 24 of the second core portion by passing via the armature 14 which it attracts, and is looped via the base 19 of the first core portion, with practically all of the flux passing through the airgaps e, given the very small size thereof compared with the distance between the base 19 of the first core portion and the base 23 of the second core portion. Only losses loop back to the central branch 20 of the first core portion by passing from the base 23 of the second core portion and through the permanent magnet 25. The airgaps thus constitutes a magnetic path for the magnetic flux generated by the coil 21.

The flux 29 generated by the coil 21 then adds its effects to the effects of the flux 27 from the permanent magnet 25 in attracting the armature 14 towards the active face 26.

At the end of the stroke, when the armature 14 is close to the active face 26, the magnetic flux 29 generated by the coil 21 may be reversed in order to control the speed with which the armature 14 docks against the active face 26.

As can be seen in FIG. 3, when the current fed to the coil is interrupted after the armature 14 has been brought to bear against the core of the electromagnet, the flux 27 generated by the permanent magnet 25 passes via the base 23 and the outer branches 24 of the second core portion 22, via the central branch 20 of the first core portion 18, and loops through the armature 14. The flux 27 from the permanent magnet 25 is then strong enough to hold the armature 14 in abutment against the core of the electromagnet 15 against the spring 12 (not shown in this figure).

The section presented to the magnetic flux from the permanent magnet 25 on passing from the core into the armature 14 is less than the area of the faces of the permanent magnet 25, thereby concentrating the flux and tending to increase the force of attraction exerted by the permanent magnet 25 on the armature 14.

As shown in FIG. 4, in order to separate the armature 14 from the core of the electromagnet 15, the coil 21 is powered so as to generate flux 28 opposing the flux 27 from the permanent magnet 25. The flux 28 generated by the coil 21 then loops in the opposite direction to that shown in FIG. 2 and thus compensates at least in part the flux 27 from the permanent magnet 25 so that the force of attraction exerted on the armature 14 is no longer sufficient to overcome the force from the spring 12. The armature 14 then leaves the active face 26 of the core of the electromagnet 15.

In a valve actuator of the invention, the flux generated by the coil 21, whether in the same direction or in the opposite direction to the flux 27 from the permanent magnet 25, thus passes via the first core portion and the second core portion without passing through the permanent magnet 25, ignoring losses.

The permanent magnet 25 is therefore subjected, at worst, only to a marginal fraction of the flux generated by the coil 21, with this marginal fraction in any event being well below the flux needed to demagnetize the permanent magnet 25, even when the coil 21 is being fed with high levels of current.

It should be observed that the airgaps e should be large enough to prevent the flux from the permanent magnet 25 looping through the base 19 of the first core portion 18 instead of through the armature 14, but the airgaps must not be too large in order to minimize flux losses generated by the coil 21 and passing through the permanent magnet.

The invention is not limited to the particular embodiment of the invention described above, but on the contrary covers any variant coming within the ambit of the invention as defined by the claim.

In particular, although the invention is described as having two electromagnets 15 fitted with permanent magnets 25, in order to be able to hold the valve in each of its extreme positions, it is possible to implement the invention with a single electromagnet fitted with a permanent magnet.

Although the invention is described with reference to actuators having electromagnets that extend in a main direction (perpendicular to the plane of the figures), the invention also applies to electromagnets that are axially symmetrical in shape. The U-shape and the T-shape to be taken into consideration, are then the shapes of the core portions as seen in axial section.

What is claimed is:

1. A dual-coil electromagnetic valve actuator having a permanent magnet and an actuator member (11) movable between two extreme positions under the effect of a resilient member and two electromagnets each comprising a core having a T-shaped first core portion (18) with a base (19) connected to a central branch (20) with a coil (21) disposed thereabout, the first core portion (18) being placed in a U-shaped second core portion (22) having a base (23) connected to outer branches (24) which extend parallel to the central branch (20) of the first core portion (18), a permanent magnet (25) being interposed between the base of the first core portion (18) and the base of the second core portion (22), wherein, in at least one of the electromagnets, the base (19) of the T-shaped first core portion (18) extends so as to co-operate with the outer branches (24) of the U-shaped second core portion (22) to present airgaps (e) of size much smaller than a distance between the base (19) of the T-shaped first core portion and the base (23) of the U-shaped second core portion.
